(19) United States
(12) Patent Application Publication
(10) Pub. No.: US 2005/0208861 A1
(43) Pub. Date: Sep. 22, 2005

(54) Asphalt coated polyester glass mats

(75) Inventors: Carlton Frederick Dwiggins, Mooresville, NC (US); Kevin Campbell, Mooresville, NC (US)

Correspondence Address: KOSA;PATENT DEPARTMENT, P.O. BOX 37388, CHARLOTTE, NC, 28237-7388, US

(73) Assignee: INVISTA North America S.a r.l.

(21) Appl. No.: 11/083,497

(22) Filed: Mar. 18, 2005

Related U.S. Application Data
(60) Provisional application No. 60/554,837, filed on Mar. 19, 2004.

(51) Int. Cl. B32B 27/12; B32B 5/12; B32B 27/04; B32B 17/02; B32B 17/04; B32B 27/02; B32B 5/02

(52) U.S. Cl. 442/415; 442/180; 442/164

(57) ABSTRACT

The present invention is based on the discovery that in order for polyester fibers to be used in a polyester/glass mat, which will have superior tear properties after being coated with bitumen, they need to have a single filament toughness of greater than about 140. Toughness being defined as the product of tenacity (in units of cN/tex) and the cube root of the breaking elongation (as a % of elongation). Specifically, the mat has polyester and glass fibers bound together with a binder, and the bound fibers are coated with asphalt. The invention also describes a process by which the web is dried and cured into a mat at a temperature of greater than about 200° C. The polyester is at least about 5 wt. % of the fibers in the coated mat.

### BACKGROUND OF THE INVENTION

This application claims the benefit of U.S. No. 60/554,837 filed Mar. 19, 2004 of the same title and by the same inventors.

1) Field of the Invention

The present invention relates to an asphalt coated polyester/glass mat that can be used for roofing shingles and other roofing applications. In particular the asphalt coated polyester/glass mat has improved tear strength compared to one made from an asphalt coated glass mat. The subject of the invention is a fiber-based mat that can be used for making bituminous membranes, comprising glass fibers and polyester fibers bound together by a binder, characterized in that the fibers have a toughness of greater than 140.

2) Prior Art

Various methods to improve the tear strength of non-woven fibrous mats for use with asphalt coatings have been devised. The majority of the patents are based on improvements to the binder system, representative of which are the following.

U.S. Pat. No. 4,335,186 discloses a chemically modified asphalt composition wherein the asphalt is reacted with a nitrogen-containing organic compound capable of introducing functional groups which can serve as reactive sites to establish a secure chemical bond between the asphalt and reinforcing fillers blended into the asphalt, such as glass fibers and siliceous aggregates.

U.S. Pat. No. 4,430,465 discloses an article of manufacture comprising a mat of fibers, such as glass fibers, coated with a composition comprising asphalt, an alkadiene-vinylarene copolymer, a petroleum hydrocarbon resin, and an anti-stripping agent of a branched organic amine.

U.S. Pat. No. 5,518,586 discloses a method of making a glass fiber mat comprising dispersing glass fibers in an aqueous medium containing hydroxyethyl cellulose to form a slurry; passing the slurry through a mat forming screen to form a wet fiber glass mat; applying a binder comprising urea-formaldehyde resin, a water-insoluble anionic phosphate ester, and a fatty alcohol to the wet glass fiber mat; and curing the binder.

U.S. Pat. No. 5,744,229 discloses a glass fiber mat made with polymer-reacted asphalt binder. The binder of the glass fiber mat comprises an aqueous emulsion of polymer modified asphalt produced by reaction of asphalt, a surfactant, and a phenol-, resorcinol-, urea- or melamine-formaldehyde resin.

U.S. Pat. No. 5,851,933 describes a non-woven fibrous mat comprising glass fibers bonded with a cured mixture of urea/formaldehyde resin and a self cross-linkable vinyl acrylic/polyvinyl acetate copolymers and U.S. Pat. No. 5,334,648 describes emulsion copolymers for use as a urea formaldehyde resin modifier.

U.S. Pat. No. 4,917,764 describes a glass fiber mat having improved strength featuring a carboxylated styrene-butadiene latex.

U.S. Pat. No. 5,804,254 describes a method for flexibilizing cured urea formaldehyde resin-bound glass fiber non-wovens.

U.S. Pat. No. 5,503,920 describes a process for improving parting strength of fiberglass insulation.

U.S. Pat. No. 5,032,431 describes a glass fiber insulation binder.

U.S. Pat. No. 4,931,318 describes silica as a blocking agent for fiberglass sizing.

U.S. Pat. No. 4,749,614 describes a fibrous substrate coated with a hydrolyzed amino silane useful for preparing polyepoxide substrates.

U.S. Pat. No. 4,596,737 describes a process for treating a glass fiber mat comprising contacting the surface of a cured mass of glass fibers with a latex polymer.

U.S. Pat. No. 4,500,600 describes glass fibers coated with a size composition comprising γ-aminopropyltriethoxysilane and an alkoxysilane.

PCT WO 99/13154 describes a structural mat matrix comprising a substrate of fiberglass fibers, wood pulp, and a binder which consists of urea formaldehyde and acrylic copolymer.

U.S. patent application Ser. No. 2001/0009834 describes a polysiloxane sizing agent.

Another group of patents utilizes scrims of polyester and glass fibers, representative of which are the following.

U.S. Pat. No. 5,695,373 describes a two-layer mat, one layer comprising a continuous filament polyester web, and the other a fiberglass mat.

U.S. Pat. No. 5,616,395 describes a process whereby two-layer polyester/glass web is bonded together.

U.S. Pat. No. 6,228,785 describes a method to improve the impact resistance of shingles by fusing a web under the asphalt shingle. This approach is also described in U.S. Pat. No. 6,341,462 in which the preferred backing material is a blend of glass fiber, polyester fiber, and a latex binder.

U.S. Pat. No. 6,426,309 describes a roofing material that has a web bonded to the lower part and a protective coating on the upper surface.

U.S. application Ser. No. 2003/0124932 describes a fiber-based mat that can be used for making up bituminous membranes comprising glass fibers, organic fibers, and a binder, characterized in that the organic fibers have a shrinkage at 130° C. of less than or equal to 5%. Although this application teaches that a polyester/glass mat has higher tear strength than glass mats alone, there is no data on asphalt or other bituminous membranes from this mat. Without such data there is no assurance that the polyester/glass mats will be able to withstand chemical attack from the asphalt or bitumen, as noted in U.S. Pat. No. 4,335,186.

While these prior mats describe uses in the roofing industry, there is a need for improved glass fiber mats having greater tear strength and toughness, on an equal basis weight of the mat, particularly when coated with asphalt or bitumen.

### SUMMARY OF THE INVENTION

The present invention is based on the discovery that polyester fibers used in a polyester/glass mat will have superior tear properties after being coated with bitumen. The polyester fibers have a single filament toughness greater than about 140. Toughness is defined as the product of tenacity (in units of cN/tex) and the cube root of the breaking elongation (as a % of elongation). The invention also describes a process by which the web is uniformly blended in a wet slurry or an air laid process, dried (if wet laid), coated with a binder, cured to form a mat at a temperature of greater than about 200° C., and coated with asphalt to form a roofing component, like a shingle.

In the broadest sense, the present invention concerns a polyester/glass asphalt roofing component having a higher tear strength compared to a glass asphalt shingle of the same basis weight.

In the broadest sense, the present invention concerns a polyester/glass asphalt roofing component, containing at least about 10 wt-% polyester, based on the weight of the polyester and glass fibers, having a higher tear strength compared to a glass fiber roofing component of the same basis weight.

In the broadest sense, the present invention concerns a polyester/glass fiber with binder and asphalt as a roofing component in which the polyester fiber has a toughness greater than about 140.

### BRIEF DESCRIPTION OF THE DRAWING

FIG. 1 is a graph showings the relationship between single fiber toughness and shingle tear strength for Example 2.

### DESCRIPTION OF THE PREFERRED EMBODIMENTS

The subject of the invention is a fiber-based mat that can be used for making bituminous membranes as a roofing component, comprising glass fibers and polyester fibers bound together by a cured binder, characterized in that the polyester fibers have a toughness greater than 140. The bound fibers are coated with asphalt to form a roofing component.

The mats are thin sheet-like materials, of an essentially isotropic structure, that is to say that there is no preferred orientation of the fibers. They are best prepared using a wet lay non-woven system. However, an air laid process can also be used. Once the wet laid fibers are de-watered, or the air laid fibers have been laid, the mat is coated with a binder, the binder is cured (by heating, for example), and the mat is now ready to be coated with asphalt.

The polyester fibers used in the mat manufacture have a high melting point in order to prevent them from degrading during the thermal steps in the manufacture of the mat, especially oven drying and cross-linking of the binder, and in the use of the mat, particularly when in contact with the bituminous binder. In general, the polyester fibers are chosen to have a melting point above about 220° C.

Fibers satisfying the requirements of the invention may be found among polyester fibers, especially polyalkylene terephthalate or polyalkylene naphthalate and particularly polyethylene terephthalate fibers.

Polyester fibers suitable for wet laid processes for manufacturing nonwovens are preferred, these fibers containing a sizing composition allowing the individual filaments to be dispersed in water.

The polyester fibers may have variable dimensions, with a mean diameter of about 7 to 50 microns for a linear density of about 0.5 to 10 dtex. The fibers are advantageously chopped to a length of the order of one millimeter to a few tens of millimeters, especially 5 to 50 mm. The length and denier are generally chosen to be comparable to that of the glass fiber.

The effect of the polyester fibers is clearly perceptible above 5% by weight with respect to the total weight of fibers. The proportion of polyester fibers is advantageously about 5 to 50%, and particularly about 10 to about 30% by weight with respect to the total weight of fibers.

The glass fibers used according to the invention are of a type conventional for the production of mat, preferably in the form of chopped yarns, having a length in the range of 5 to 50 mm and preferably about 10 to 40 mm, for example 25 to 35 mm.

The binder used to form the mat is advantageously based on a urea-formaldehyde resin. The amount of binder generally corresponds to a solids content of from 15 to 30% by weight with respect to the mat (the polyester/glass fibers and the cured binder).

The wet laid web and binder are preferably rapidly dried and cured. This can be achieved by using an oven, or a drum, at a set temperature of greater than about 200° C. Generally the dry and cured web will leave the oven or drum at a temperature sufficient to cure the binder.

The mat is manufactured with a basis weight, usual for glass mats, of about 30 to 150 g/m², particularly 50 to 120 g/m².

Given the difference in density between glass and polyester fibers, the amount of material in the mat according to the invention for a given basis weight is slightly greater than that contained in a glass mat, which means that the thickness and porosity may change with the addition of polyester fibers.

Since the mat according to the invention is particularly suitable for roofing applications, the subject of the invention is also a bituminous membrane comprising a substrate coated, covered, or impregnated with a bituminous matrix, characterized in that the substrate is a mat as described above.

The bituminous matrix may be chosen from matrices known per se: natural, modified or unmodified bitumen, or a synthetic binder such as a “light-colored binder” making it possible in particular to give the membrane a decorative color, as known in the art.

The following non-limiting examples illustrate the invention.

### Test Procedures

ASTM D 3462-03 “Standard Specification for Asphalt Shingles Made From Glass Felt and Surfaced with Mineral Granules” was used where possible. D 1922 was used to measure the tear strength of the mat and shingle. D 146 was used to measure the tensile strength and elongation. The retention in strength when the shingle was bent 90° over a 1.27 cm radius (flex %) was measured using the principles of D 5683.

The fiber single filament properties are measured according to ASTM D 3822-01. A gauge length of 25 mm was used with a strain rate of 100%/minute using a Textechno Fafegraph instrument. Toughness is defined as the product of tenacity (cN/tex) and the cube root of the breaking elongation (%). Fiber shrinkages were measured dry at 177° or 204 C, and wet at 130° C. using a pressure dye can.

### EXAMPLES

The mats were made on a 75 cm pilot wet lay nonwoven line. The stock tanks (500 liter) were filled ½-¼ full, polyester fibers were added, dispersion/viscosity chemicals (80 ml Rhodameen VP 532, 6 ml Nalco 7514 antifoam and 1 wt. % Nalco 2388 viscosity modifier based on the weight of the chemicals) were added, and they were allowed to mix for several minutes. White water flow (28.5 l/min.) and vacuum were started, and then the stock fed to the head box. Wet web formed as water is removed over several suction slots, and the wet web was transferred to a second wire belt to carry it to the dryer. The line speed was 1.5 m/min.

The binder was applied by a curtain coater on the second wire belt, positioned just before a vacuum slot to pull the binder through, saturating the web. There was at least one more vacuum slot before the web was transferred to the dryer wire. The binder was cured by passing it through a Honeycomb dryer at 240° C. At a line speed of 1.5 meters/minute/the residence time is ˜28 seconds.

The cured mat was coated on both sides with 183° C. softening point asphalt, filled to 60% with limestone shingle coating filler. Coating was done by attaching the mat to a metal pan, pouring asphalt heated to about 227 to 230° C., and using a metal squeegee to saturate the mat. It was then turned over and the coating repeated. Generally with a mat basis weight of 100 g/m², the shinglet had a target basis weight of 1100 g/m².

Unless otherwise stated, all the examples used M-glass (16 micron, Owings Corning) fibers. The binder consisted of an aqueous emulsion (5 to 10 wt. % solids) of a mixture of 92 wt-% Borden SU100 urea-formaldehyde and 8 wt-% Rhoplex GL618 latex. A fiber blend ratio of 20 wt-% polyester fiber and 80 wt % glass fiber was used. The target binder amount was 24 wt. % and the remaining 76 wt. % was the polyester/glass fibers.

A series of commercial (Invista, Salisbury, North Carolina, USA) polyester fibers (2.54 cm cut length) was used, their physical properties are set forth in Table 1.

TABLE 1

| | Fiber No. | | | | | |
|---|---|---|---|---|---|---|
| | 1 | 2 | 3 | 4 | 5 | 6 |
| Type | 787 | 785 | 787 | 787 | 103 | 103 |
| Denier | 6.9 | 7.0 | 5.6 | 6.0 | 5.6 | 5.5 |
| Tenacity, cN/tex | 78.5 | 79.4 | 77.7 | 75.9 | 52.9 | 52.1 |
| Elongation, % | 32 | 20 | 32 | 39 | 38 | 30 |
| Toughness | 222 | 195 | 220 | 228 | 158 | 144 |
| Shrinkage, 170° | 3.0 | 9.2 | n.m. | n.m. | n.m. | n.m. |
| Shrinkage, 204° | n.m. | n.m. | 12.5 | 4.5 | 11.5 | 8.0 |
| Wet Shrinkage, 130° | 2.4 | 7.6 | n.m. | n.m. | n.m. | n.m. |

n.m.—not measured

### Example 1

In order to repeat the teachings of the prior art, U.S. patent application Ser. No. 2003/0124932, fibers 1 and 2 were compared as mats and coated shingles. The blend level was 20 wt % polyester with 80% 2.54 cm length glass fiber. The results, compared to 100% glass mat (both with 24% binder) are set forth in Table 2.

TABLE 2

| | Fiber Identification | | |
|---|---|---|---|
| | 1 | 2 | Glass |
| Mat basis weight, g/m² | 93.7 | 89.8 | 87.4 |
| Binder, % | 22.3 | 21.7 | 22.3 |
| Mat tear, g | 746 | 665 | 318 |
| Shingle Tensile Strength, N/2.54 cm | 269 | 284 | 372 |
| Shingle Elongation, % | 4.8 | 5.2 | 5.4 |
| Flex, % | 91 | 81 | 75 |
| Tear, g | 1184 | 1123 | 1011 |

This example shows that fiber shrinkage (in steam at 130° C.) does not influence either mat or shingle physical properties. In addition both fibers gave a shingle with higher tear strength than 100% glass. It should be noted that the large increase (a factor of 2) in uncoated mat tear strength of glass mats by the addition of polyester fibers does not give the same large increase after coating.

The difference in the method of this Example compared to that described in U.S. patent application Ser. No. 2003/0124932 is that the web was dried and the binder cured at a constant temperature of 240° C. U.S. patent application Ser. No. 2003/0124932 used a drying and curing method consisting of an oven having several temperature zones from 135 to 215° C. It is believed that the lower initial temperature of the oven allowed the high shrinkage fiber to shrink before the binder resin cures, causing the noted wrinkling of the web after the web left the oven.

### Example 2

Mats and shingles were produced using the other fibers identified in Table 1, using a 20 wt. % polyester fiber/80 wt % glass fiber (2.54 cm length). The results, with a 100% glass control, both with 24% binder, are set forth in Table 3.

TABLE 3

| | Fiber Identification | | | | | |
|---|---|---|---|---|---|---|
| | 3 | 4 | 5 | 6 | 1 | Glass |
| Mat basis weight, g/m² | 96.7 | 91.8 | 99.1 | 99.6 | 103.5 | 89.8 |
| Binder, % | 22.6 | 23.0 | 23.2 | 22.0 | 23.1 | 21.4 |
| Mat tear, g | 747 | 699 | 551 | 561 | 836 | 331 |
| Shingle Tensile | 289 | 314 | 311 | 296 | 332 | 326 |
| Strength* | | | | | | |
| Shingle Elongation, % | 4.8 | 4.9 | 4.6 | 4.5 | 4.7 | 4.5 |
| Flex, % | 85 | 88 | 79 | 91 | 86 | 88 |
| Tear, g | 1082 | 1120 | 878 | 872 | 1035 | 730 |

*N/2.54 cm

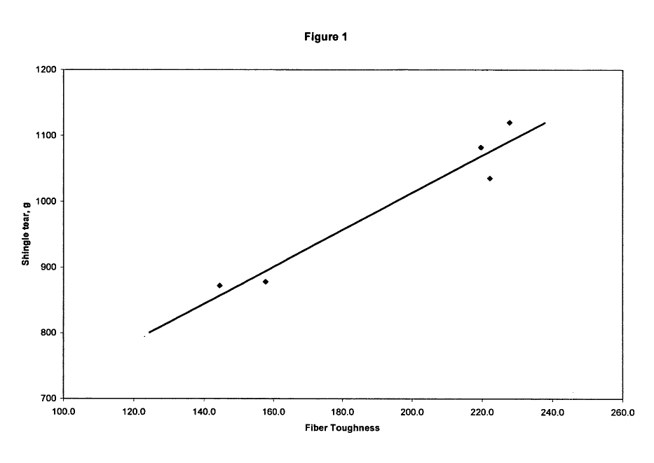

FIG. 1 shows the relationship between single fiber toughness and shingle tear strength for this Example.

### Example 3

100% glass fiber shingles exhibited tear strength of 1011 g in Example 1 and 730 for Example 2. In order to better define the glass shingle tear strength, another series of mats were prepared with 100% glass fibers having a cut length of 3.8 cm and 20 wt % polyester fiber/80 wt. % glass fiber blend with fibers 3 and 4, which have a large difference in shrinkage characteristics. A single series of mats were prepared and these were coated with asphalt in two separate trials. The results are set forth in Table 4.

TABLE 4

| | Fiber Identification | | |
|---|---|---|---|
| | 3 | 4 | Glass |
| Mat basis weight, g/m² | 100.6 | 101.5 | 97.2 |
| Binder, % | 24.6 | 24.1 | 24.8 |
| Mat tear, g | 810 | 962 | 356 |
| Trial 1 | | | |
| Shingle Tensile Strength, N/2.54 cm | 248 | 273 | 299 |
| Shingle Elongation, % | 3.0 | 3.9 | 3.1 |
| Flex, % | 98 | 89 | 99 |
| Tear, g | 1262 | 1344 | 931 |
| Trial 2 | | | |
| Shingle Tensile Strength, N/2.54 cm | 283 | 289 | 335 |
| Shingle Elongation, % | 4.0 | 4.1 | 4.1 |
| Flex, % | 77 | 91 | 80 |
| Tear, g | 1243 | 1234 | 790 |

The tear strength of the shingles from the 20 wt % polyester blend is consistent between the trials.

The average tear strength of the 100% glass shingles in theses three Examples is 865 g. This can be matched with a 20 wt % blend of polyester fibers which have a toughness of greater than about 140. To obtain a 20 wt % improvement in shingle tear strength (1000 g) will require a fiber toughness of greater than or equal to about 200.

Thus it is apparent that there has been provided, in accordance with the invention, a process that fully satisfied the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the appended claims.

1) a polyester/glass asphalt shingle having a higher tear strength compared to a glass shingle of the same basis weight.

2) A polyester/glass asphalt shingle, containing at least about 10 wt-% polyester of the fiber content, having a higher tear strength compared to a glass shingle of the same basis weight.

3) A polyester/glass asphalt shingle in which the polyester fiber has a toughness greater than about 140.

4) A method of preparing a polyester/glass mat comprising: uniformly blending polyester and glass fibers in an aqueous slurry; pouring said slurry on a drum or screen; de-watering said wet laid mat; coating said dried mat with a binder; curing said mat at a temperature above 200° C., and coating with asphalt.

5) A roofing shingle comprising: a uniform blend of polyester and glass fibers, and a binder, said fibers and binder coated with asphalt thereby forming a shingle.

6) The roofing shingle of claim 5, wherein said fibers are from about 5 to about 50 wt. % polyester fibers and from about 95 to about 50 wt. % glass fibers.

7) The roofing shingle of claim 6, wherein said polyester/glass fibers have a length in the range of about 5 to about 50 mm.

8) The roofing shingle of claim 6, wherein said polyester/glass fibers have a mean diameter of about 7 to 50 microns, for a linear density of about 0.5 to 10 dtex.

9) The roofing shingle of claim 5, wherein said binder is urea-formaldehyde resin.

10) The roofing shingle of claim 9, wherein said binder is from about 15 to about 30% by weight of said blend of fibers.

11) The roofing shingle of claim 5, wherein said polyester fiber has a toughness greater than about 140.
